(19) United States
(12) Patent Application Publication
(10) Pub. No.: US 2026/0298411 A1
(43) Pub. Date: Oct. 1, 2026

(54) METHOD AND SYSTEM FOR STORING HYDROGEN

(71) Applicant: TechnipFMC Norge AS, Kongsberg (NO)

(72) Inventors: Svein Kjenner, Kongsberg (NO); Ausen Håvard, Kongsberg (NO)

(21) Appl. No.: 19/477,006

(22) PCT Filed: Apr. 19, 2024
(86) PCT No.: PCT/EP2024/060667

§ 371 Date: Oct. 20, 2025

(30) Foreign Application Priority Data
Apr. 20, 2023 (NO) 20230424

(51) Int. Cl. F17C 5/06; C25B 1/04; C25B 15/023; C25B 15/08; F17C 1/00; F17C 13/04

(52) U.S. Cl. CPC F17C 5/06; C25B 1/04; C25B 15/023; C25B 15/08; F17C 1/007; F17C 13/04; F17C 2205/0134; F17C 2205/0388; F17C 2221/012; F17C 2223/036; F17C 2227/0157; F17C 2250/03; F17C 2270/0128

(57) ABSTRACT

A method for storing hydrogen in a plurality of subsea storages in a system. The system comprising an electrolyser source for producing hydrogen at a source pressure; a downstream compressor for compressing the hydrogen from the source pressure to a compressed higher pressure; and a plurality of storages, each for storing compressed hydrogen at the compressed higher pressure and each being subsea. The method comprising at least the steps of: producing hydrogen by the electrolyser source at the source pressure; passing the hydrogen to the plurality of storages through a bypass line around the compressor; and storing the hydrogen in at least one of the plurality of storages at a first pressure below the compressed higher pressure. A system for storing hydrogen in a plurality of subsea storages is also disclosed.

### TECHNICAL FIELD

The present disclosure relates to a method for storing hydrogen in a plurality of subsea storages in a system, and to the system for storing hydrogen in the plurality of subsea storages. More particularly, the present disclosure relates to subsea storage of hydrogen and how to realise such storage efficiently.

### BACKGROUND

Power in the form of electricity may be created by wind turbines, wave energy, etc. The amount of created electric power may change, because the electric power derives from natural resources. Sometimes there will be an excess of electric power, and sometimes there will be a deficiency of electric power. Therefore, the electric power is used to split water into hydrogen and oxygen by electrolysis. The hydrogen can then be stored for future use, for example, converted back into electricity when needed.

It is a problem to effectively store the hydrogen considering energy and costs. Hydrogen is compressed and stored in tanks, and it is a problem that the compression of hydrogen requires energy. A compressor uses electric energy, and it is desirable to keep this consumption of electric energy as low as possible. It is also desirable to reduce wear on the compressor and increase its life span.

A further problem is that the hydrogen storage takes place subsea, possibly at several hundred meters depth, and must be able to withstand pressure from the outside also. This results in further problems such a high pressures, water current, darkness, presence of water, difficulty or even impossibility to perform maintenance in situ, etc. The environment is, therefore, challenging with respect to maintenance. The storage must also comply with possible regulations and standards in the oil and gas industry. A further problem is that any subsea storage for the hydrogen must be able to hold pressurised hydrogen acting on the inside of the storage and/or must be able to withstand the pressure from the outside due to being subsea.

A further technical problem is that any part of storing hydrogen must function without a possibility of failure, fulfill technical and legal requirements, and be easy to use. It is desirable that any solution be simple, not expensive to produce, and reliable. It is further a technical problem to avoid cumbersome arrangements that are expensive to manufacture or assemble.

### SUMMARY

Embodiments of the present disclosure provide a method for storing hydrogen in a plurality of subsea storages in a system, and to the a system for storing hydrogen in the plurality of subsea storages.

According to one embodiment, a method for storing hydrogen in a plurality of subsea storages in a system is disclosed. The system comprises an electrolyser source for producing hydrogen at a source pressure; a downstream compressor for compressing the hydrogen from the source pressure to a compressed higher pressure; and a plurality of storages, each for storing compressed hydrogen at the compressed higher pressure and each being subsea. The method comprises two alternative sets of steps for storing hydrogen. The first set of steps: producing hydrogen by the electrolyser source at the source pressure; passing the hydrogen to the plurality of storages through a bypass line around the compressor; and storing the hydrogen in at least one of the plurality of storages at a first pressure below the compressed higher pressure. The second set of steps: producing hydrogen by the electrolyser source at the source pressure; compressing the hydrogen with the compressor to a storage pressure less than the compressed higher pressure; and storing the produced and compressed hydrogen in at least one of the plurality of storages at the storage pressure less than the compressed higher pressure.

According to one embodiment, a system for storing hydrogen in a plurality of subsea storages is disclosed. The system comprises an electrolyser source for producing hydrogen at a source pressure; a downstream compressor for compressing the hydrogen from the source pressure to a compressed higher pressure; a plurality of storages each for storing compressed hydrogen at the compressed higher pressure and each being subsea; and a controller for controlling the electrolyser source, the downstream compressor, and valves to the plurality of storages. The controller is configured for controlling the system in, at least, two alternative ways A) and B). A) is passing the hydrogen, produced by the electrolyser source at the source pressure, to the compressor, compressing the hydrogen by the compressor to a compressed higher pressure, and passing the hydrogen, at the compressed higher pressure, from the compressor to at least one of the plurality of subsea storages. B) is passing the hydrogen, produced by the electrolyser source at the source pressure, to at least one of the plurality of storages, through a bypass line around the compressor at a first pressure below the compressed higher pressure.

Other technical advantages of the present disclosure will be readily apparent to one skilled in the art from the following description and claims. Various embodiments of the present application obtain only a subset of the advantages set forth. No one advantage is critical to the embodiments.

### BRIEF DESCRIPTION OF THE DRAWINGS

The accompanying drawings illustrate presently example embodiments of the disclosure and serve to explain, by way of example, the principles of the disclosure.

FIG. 1 is a diagrammatic and schematic illustration of a system according to an example embodiment of the disclosure;

FIG. 2 is a diagrammatic illustration of a system according to a further example embodiment of the disclosure; and

FIG. 3 is a diagrammatic illustration of a method according to an example embodiment of the disclosure; and

FIG. 4 is a diagrammatic illustration of a method according to an example embodiment of the disclosure.

### DETAILED DESCRIPTION

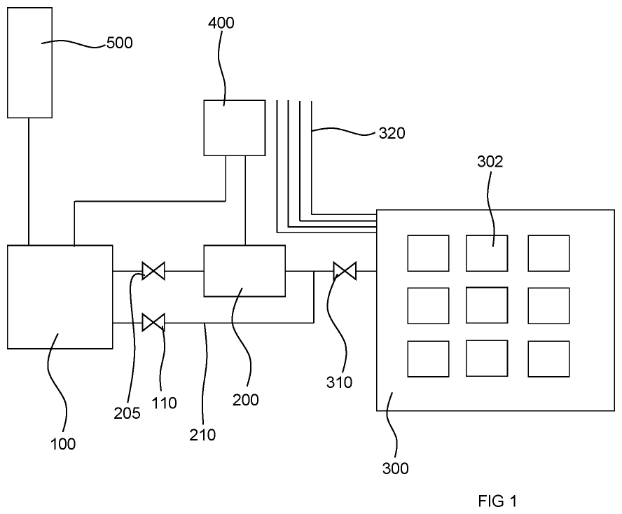

FIGS. 1 to 3 illustrate example embodiments of the method and system for storing hydrogen. The first two figures are generally the same system, but differ in how a compressor 200 is bypassed. The last figure is a flow chart of the method for storing hydrogen in a plurality of subsea storages.

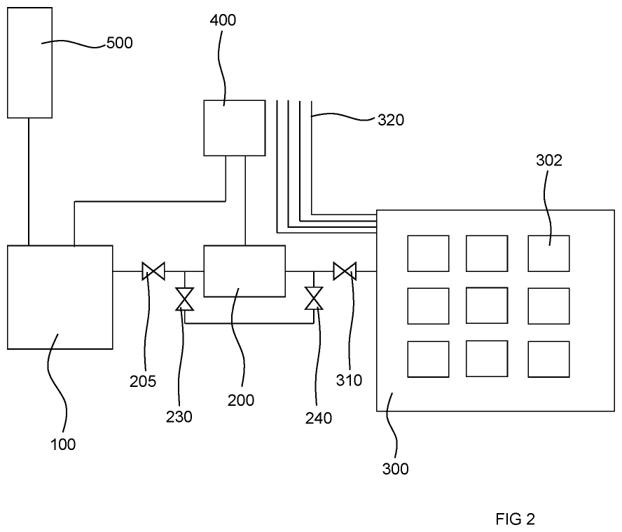

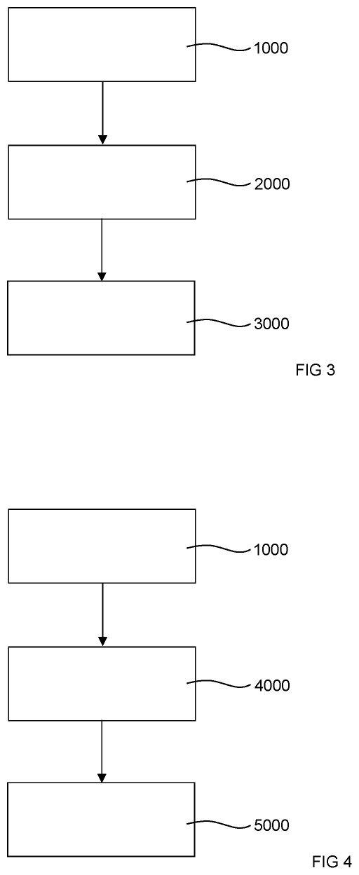

Turning first to FIG. 3, a method for storing hydrogen in a plurality of subsea storages in a system is shown in a flow chart. The system comprises an electrolyser source 100 for producing hydrogen at a source pressure; a downstream compressor 200 for compressing the hydrogen from the source pressure to a compressed higher pressure; and a plurality of storages 300 each for storing compressed hydrogen at the compressed higher pressure and each being subsea. The system is described with reference to FIGS. 1 and 2, and is further explained herein. The method uses the system described herein and stores efficiently the hydrogen in the plurality of subsea storages 300 of the system. The method comprising at least the steps of: producing hydrogen 1000 by the electrolyser source 100 at the source pressure; passing the hydrogen 2000 to the plurality of storages 300 through a bypass line 210 around the compressor 200; and storing the hydrogen 3000 in at least one of the plurality of storages 300 at a first pressure below the compressed higher pressure.

The electrolyser source 100 produces hydrogen at a source pressure. The electrolyser source 100 may use electric energy from an electric energy producer 500. The hydrogen produced by the electrolyser source 100 may be proportional to the electric energy produced by the energy producer 500. The electrolyser 100 has higher efficiency at lower loads, while the compressor 200 has lower efficiency at low loads.

The system uses the compressor 200 for compressing hydrogen for storage. When, for example, there is low production of electric energy, or the need for hydrogen is present or imminent, then the hydrogen can be stored without first compressing the hydrogen further when it leaves the electrolyser 100. The hydrogen may be stored for future use, such as, for example, converting it back into electricity when needed. By not always compressing the produced hydrogen from the electrolyser source 100 before storing it, the hydrogen is effectively stored considering energy and costs. The electric energy that the compressor uses will be less, and wear on the compressor is reduced along with its life span increased. The bypass line 210 is described below.

Hydrogen compression accounts for, for example, five to ten percent of the energy required to produce hydrogen at, for example, 35 MPa (350 bar). Taking advantage of the electrochemical compression in the electrolyser source 100, which may be, for example, 3 MPa (30 bar), the subsequent compression of the hydrogen for the plurality of storages 300 can be eliminated, and this increases efficiency. That is, the system for subsequent compression of the hydrogen for the plurality of storages 300 can be bypassed until reaching the limit of electrochemical compression. This also reduces wear on the compressor and increases the system's lifespan. For low hydrogen rates, the relative energy required might be much higher if the compressor requires a recycle valve. The compressor power is largely determined by the compressor size and less on the rate. When there is little renewable energy available, the compression can account for a large portion of the energy needed. The present method and system avoids this.

By allowing hydrogen production and storage using less energy, a wider range of renewable energy can be stored as hydrogen, and this increases plant efficiency and improves economy. As explained herein, this can be achieved, for example, by keeping some of the available storage 300 in low pressure, for example, less than 3 MPa (30 bar). The plurality of storages 300 are each for storing hydrogen at a compressed higher pressure, but using some of these storages 300 for storing hydrogen at a lower pressure, for example, lower than the pressure produced by the compressor 200, or at the pressure produced by the electrolyser source 100, the source pressure, reduces the relative energy for storing the hydrogen. When the plurality of storages have volume available for storage, then the subsequent compression can be eliminated by passing the hydrogen from the electrolyser source 100 to the plurality of storages 300 through the bypass line 210 around the compressor 200.

One of the many advantages of this is that if one or more of the plurality of storages 300 are filled with low pressure hydrogen, then that one or more of the plurality of storages 300 can easily be converted to high pressure storage by simply storing hydrogen at the compressed higher pressure. As more and more hydrogen storage is needed, a tank 302 in the storage 300 with lower pressure hydrogen, for example, with source pressure hydrogen, can be converted to a tank 302 in the storage 300 with higher pressure as needed until all tanks in the storage 300 are filled with hydrogen at the compressed higher pressure, and this method does not reduce the overall storage capacity. This is specifically so for already existing storage systems that can be modified and run more efficiently. A further advantage is that only one type of pressure tanks 302 is needed, the tanks 302 for storing compressed hydrogen at the compressed higher pressure. There is thus no need to have two different tanks, i.e., high pressure tanks and low pressure tanks.

The below table calculates efficiency based on the below data examples with a fixed efficiency, not taking into account a possible compressor recycle. If a recycle is needed for the compressor, then the efficiency of the compressor will be very low, having a much higher apparent mass rate than the useful work being done.

| | kg hydrogen | Compression | Kg hydrogen | Relative |
|---|---|---|---|---|
| Power | without | power kwh | with | increase in |
| kwh | compression | required | compression | hydrogen mass |
| 85 | 1.232363 | 1.9 | 1.204816 | 2% |
| 30.75 | 0.445825 | 1 | 0.431327 | 3% |
| 29.75 | 0.431327 | 1 | 0.416829 | 3% |

The data examples for this table are:
2-4 kwh/kg for compression from 2 MPa to 35 MPa (from 20 bar to 350 bar).
Compressor: 1.6-5 kwh/kg depending on hydrogen rate. Lower efficiency for lower rates.
Electrolyser efficiency: 68.9/66.7/64.5 kwh/kg
Electrolyser supply pressure: 3 MPa gauge pressure (30 barg)
Storage pressure: 35 MPa (350 bar)

Turning to FIGS. 1 and 2, a system for storing hydrogen in a plurality of subsea storages is schematically illustrated. The system comprises an electrolyser source 100 for producing hydrogen at a source pressure; a downstream compressor 200 for compressing the hydrogen from the source pressure to a compressed higher pressure; a plurality of storages 300 each for storing compressed hydrogen at the compressed higher pressure and each being subsea; and a controller 400 for controlling the electrolyser source 100, for controlling the downstream compressor 200, and for controlling valves 310 to the plurality of storages 300.

The controller 400 is configured for controlling the system in, at least, two alternative, different, ways, A) and B). The controller 400 is thus able to control the system as in A) or as in B), depending on the selection made, but it is important that the controller is configured for A) and for B).

The alternative A) is passing the hydrogen, produced by the electrolyser source 100 at the source pressure, to the compressor 200, compressing the hydrogen by the compressor 200 to a compressed higher pressure, and passing the hydrogen, at the compressed higher pressure, from the compressor 200 to at least one of the plurality of subsea storages 300.

The alternative B) is passing the hydrogen, produced by the electrolyser source 100 at the source pressure, to at least one of the plurality of storages 300, through a bypass line 210 around the compressor 200 at a first pressure below the compressed higher pressure. In embodiments, the first pressure is the source pressure generated by the electrolyser source 100.

By providing a system where the controller 400 is able to control the system to store hydrogen according to alternative A) and according to alternative B), an efficient storage of hydrogen is achieved. When, for example, there is low production of electric energy, or the need for hydrogen is present or imminent, then the hydrogen can be stored according to alternative B). However, when there is a high, more than needed, production of electric energy, then the hydrogen can be stored according to alternative A). By not always storing hydrogen according to alternative A), but according to alternative B) when there is low production of energy, the hydrogen is effectively stored considering energy and costs. The electric energy that the compressor uses will be less, and wear on the compressor is reduced along with its life span increased.

The subsea plurality of storages 300 may comprise several tanks 302, units, in parallel, and may have a plurality of lines 320, for example, four lines 320, going to a topside to allow purging and maintenance of the tanks 302. One of the plurality of lines 320 could be dedicated to low pressure hydrogen, for example, the first pressure, or the source pressure. That dedicated line may be isolated from the high pressure part, storing the hydrogen at the compressed higher pressure.

Depending on what storage tanks are used, the plurality of storages 300 need not to be configured for under-pressure, even if they are subsea, since they may have an internal minimum pressure equal to the surroundings. This would, for example, limit the use of this option to a sea depth equal to 30 bar, or 300 meters below sea level, for a method and system where the electrolyser source 100 produces a source pressure that is 3 MPa (30 bar). For example, if the electrolyser source 100 produces a source pressure that is 4 MPa (40 bar), then the plurality of storages 300 may be on 400 meters depth, and so on. This option would be able to use inexpensive and simple subsea storage tanks 300 as long as the source pressure of the electrolyser 100 is at least equal to the subsea water pressure where the storage tanks 300 are. As an alternative to this option, the plurality of storages 300 may be configured to withstand the pressure from the outside when there is no pressure from the inside by hydrogen.

The bypass line 210 around the compressor 200 may be a line that is parallel to the compressor. The bypass line 210 may lead the hydrogen at the source pressure directly from the electrolyser source 100 to the plurality of storages 300. The bypass line 210 may be a hose, conduit, tube, or similar for transporting hydrogen with a valve 110 as in FIG. 1, or valves 230, 240 at both ends of the line 210, so that the bypass line 210 may be opened and closed for transporting the hydrogen at the source pressure directly from the electrolyser source 100 to the plurality of storages 300. The bypass line 210 may start directly from the electrolyser source 100, or on a line between the electrolyser source 100 and the compressor 200. The bypass line 210 may end directly at the plurality of storages 300, or on a line between the compressor 200 to the plurality of storages 300. In some embodiments, the compressor 200 may have separate valves 230, 240 before and after the compressor 200 that allows the compressor 200 to be shut off from hydrogen flow. There may be a valve 205 on the line between the electrolyser source 100 and the compressor 200. There may be a valve 310 on the line between the compressor 200 and the plurality of storages 300. All these valves 110, 205, 230, 240, 310 may be controlled by the controller 400.

Turning to FIGS. 1 and 2, the electrolyser source 100 receives electricity from an energy generating device 500, for example, solar energy, wind energy, geothermal energy, hydropower, ocean energy, or bioenergy. The energy generating device 500 may include a generator that generates electricity, electric power. The electrolyser source 100 produces hydrogen at a source pressure. The electrolyser source 100 may use electricity from the energy generating device 500 or from a battery. The downstream compressor 200 compresses the hydrogen from the source pressure to a compressed higher pressure. The compressor 200 is downstream of the electrolyser 100 and may use the electricity from the energy generating device 500 or from a battery. The plurality of storages 300 may each store compressed hydrogen at the compressed higher pressure and each of the storages are subsea. The electrolyser source 100 and/or the compressor 200 may be subsea, offshore, or onshore. The controller 400 controls the electrolyser source 100, the downstream compressor 200, and valves 310 to the plurality of storages 300. The controller 400 may also control further valves 205 and 110. By closing the valve 110 and opening valves 205 and 310, the hydrogen from the electrolyser source 100 may be lead to the compressor 200 and then to the plurality of storages 300. This corresponds to alternative A) mentioned herein. By closing the valve 205 and opening valves 110 and 310, the hydrogen from the electrolyser source 100 may be led to the plurality of storages 300. This corresponds to alternative B) mentioned herein. The controller 400 is thus configured for controlling the system in, at least, these two alternative ways of leading the hydrogen from the electrolyser 100 to the plurality of storages 300.

The plurality of storages 300 comprises a plurality of tanks 302. Each tank 302 is for storing compressed hydrogen at the compressed higher pressure. Each tank 302 is subsea. In FIG. 1, there are nine tanks 302 schematically illustrated, but there could be more or fewer tanks 302. The tanks 302 may be connected in series or in parallel. The controller 400 may lead the hydrogen to each tank 302 independently of the other tanks 302. The controller 400 may also lead the hydrogen away from each tank 302 independently of the other tanks 302. This may be done using one of the four lines 320 going to the topside to allow purging and maintenance of the tanks 302. One of these four lines could be dedicated to low pressure hydrogen, for example, the first pressure or the source pressure. That dedicated line may be isolated from the high pressure part, storing the hydrogen at the compressed higher pressure.

Turning to FIGS. 1 and 2, the controller 400 and/or the compressor 200 may be above sea level, the topside. This renders easy access to the controller 400 and/or the compressor 200. The four lines 320 may lead to the topside, where the controller 400 and/or the compressor 200 are, to allow purging and maintenance of the tanks 302. The controller 400 and/or the compressor 200 may instead be subsea.

FIGS. 1 and 2 schematically illustrates the plurality of storages 300. The plurality of storages 300 may comprise a plurality of tanks 302 for storing hydrogen at the compressed higher pressure. The plurality of storages 300, the plurality of tanks 302, are connected in series or in parallel. The plurality of storages 300 may further comprise controllable valves for individually filling or individually emptying each of the plurality of storages 300, the tanks 302. The controllable valves may be controlled by the controller 400.

As illustrated in FIGS. 1 and 2, the system may further comprise an electric energy producer 500. The electric energy producer 500 may be one or a combination thereof, for example, solar energy, wind energy, geothermal energy, hydropower, ocean energy, or bioenergy. The energy generating device 500 may include a generator that generates electricity, electric power. The controller 400 may be further configured for controlling the electric energy producer 500.

Turning to the plurality of storages 300, each of the plurality of storages 300, each the tank 302, may be configured to be constantly pressurised with at least a pressure in kPa that is equal to 10 times a subsea depth in meters of the plurality of storages 300. This allows the use of storage tanks 302 that do not take under-pressure, and must therefore be pressurised with at least a pressure equal to the depth in meters where they are placed subsea. For example, if the plurality of storages 300 are 300 meters down below the sea level, then they have to have a pressure of 3000 kPa or more.

The electrolyser source 100 may be configured to produce hydrogen at the source pressure in kPa that is higher than 10 times the subsea depth in meters of the plurality of storages 300. As above, this allows the use of storage tanks 302 that do not take under-pressure, and must therefore be pressurised with at least a pressure equal to the depth in meters where they are placed subsea. For example, if the plurality of storages 300 are 300 meters down below the sea level, then they have to have a pressure of 3000 kPa or more.

The system may further comprise four conduits 320 leading from the plurality of storages 300 to a topside at, or above, sea level for purging and maintaining the plurality of storages 300. One conduit 320 of the four conduits may be dedicated for passing hydrogen at the first pressure. As explained above, the subsea storage 300 may comprise several units 302 in parallel and have four lines going to the topside to allow purging and maintenance of the tanks 302. One line 302 of these lines could be dedicated to low pressure hydrogen, hydrogen at the source pressure, and isolated from the high pressure part, the compressed higher pressure part.

The first pressure may be the source pressure. This results in that the hydrogen is stored in at least one of the plurality of storages 300 at the source pressure from the electrolyser 100, which is at a pressure below the compressed higher pressure. The first pressure may be lower than the source pressure. This results in that the hydrogen is stored in at least one of the plurality of storages 300 at a pressure lower than the source pressure from the electrolyser 100, which is at a pressure below the compressed higher pressure. The first pressure may be higher than the source pressure and lower than the compressed higher pressure. This results in that the hydrogen is stored in at least one of the plurality of storages 300 at a pressure higher than the source pressure from the electrolyser 100 but at a pressure below the compressed higher pressure.

With reference to FIGS. 1 to 4, especially FIGS. 3 and 4, the method, as described above, may further comprise, as an additional alternative to the two steps of passing the hydrogen 2000 through the bypass line 210 around the compressor 200, and of storing the hydrogen 3000 in at least one of the plurality of storages 300 at a first pressure below the compressed higher pressure, the following steps. Compressing the hydrogen 4000 with the compressor 200 to a storage pressure less than the compressed higher pressure; and storing the produced and compressed hydrogen 5000 in at least one of the plurality of storages 300 at the storage pressure less than the compressed higher pressure. In this way, some energy is still saved since the compressor 200 is not fully used. Alternatively, a second compressor 200 may be used that pressurises the hydrogen to the storage pressure less than the compressed higher pressure.

With reference to FIGS. 1 to 4, especially FIGS. 3 and 4, the method, as described above, may further comprise a controller 400 configured for controlling the electrolyser source 100, the compressor 200, and valves 310 to the plurality of storages 300. The valves 310 may be any valves for hydrogen lines between the electrolyser source 100 and the plurality of storages 300. This may be an embodiment of the controller 400 configured for A) and B) as described above. The method may further comprise that the controller 400 alternates between the following two. On one hand, when less hydrogen is produced than a predetermined amount: passing the hydrogen 2000 to the plurality of storages 300 through a bypass line 210 around the compressor 200; and storing the hydrogen 3000 in at least one of the plurality of storages 300 at a first pressure below the compressed higher pressure. On the other hand, when more hydrogen is produced than a predetermined amount: compressing the hydrogen 4000 with the compressor 200 to a storage pressure less than the compressed higher pressure; and storing the produced and compressed hydrogen 5000 in at least one of the plurality of storages 300 at the storage pressure below the predetermined pressure. The predetermined amount of produced hydrogen may be the amount produced by the electrolyser using the electric energy produced by the electric energy producer 500. The amount of hydrogen produced may be proportional to the electric energy produced by the electric energy producer 500. Thus, on the one hand, for example, there is low production of electric energy, or the need for hydrogen is present or imminent, then the hydrogen can be stored according to alternative B). On the other hand, for example, when there is a high, more than needed, production of electric energy, then the hydrogen can be stored according to alternative A).

With reference to FIGS. 1 to 4, especially FIGS. 3 and 4, the system, as described above, may further comprise an electric energy producer 500, and the controller 400 may be further configured for controlling the electric energy producer 500. The method, as described above, may further comprise producing electric energy with the electric energy producer 500; and conduct at least a part of the electric energy to the electrolyser source 100 for producing hydrogen at a source pressure. This allows the controller 400 to also control the energy input from the electric energy producer 500 to the electrolyser source 100 and to the compressor 200.

With regard to the method described herein, the first pressure may be the source pressure. This results in that the hydrogen is stored in at least one of the plurality of storages 300 at the source pressure from the electrolyser 100, which is at a pressure below the compressed higher pressure. The first pressure may be lower than the source pressure. This results in that the hydrogen is stored in at least one of the plurality of storages 300 at a pressure lower than the source pressure from the electrolyser 100, which is at a pressure below the compressed higher pressure. The first pressure may be higher than the source pressure and lower than the compressed higher pressure. This results in that the hydrogen is stored in at least one of the plurality of storages 300 at a pressure higher than the source pressure from the electrolyser 100 but at a pressure below the compressed higher pressure.

With regard to FIGS. 1-4, the method described herein may further comprise configuring the electrolyser source 100 to produce hydrogen at the source pressure in kPa that is equal to, or higher, than 10 times the subsea depth in meters of the plurality of storages 300. For example, if the plurality of storages 300 are 300 meters below sea level, then the electrolyser source 100 is configured to produce hydrogen at the source pressure of 3000 kPa or more. This allows the use of storage tanks 302 that do not take under-pressure, and must therefore be pressurised with at least a pressure equal to the depth in meters where they are placed subsea.

With regard to FIGS. 1-4, the method described herein may further comprise that hydrogen may always be deducted from a predetermined single tank 302, or a predetermined set of tanks 302, of the plurality of storages 300 until the predetermined single tank 302, or the predetermined set of tanks 302, are at the first pressure. This allows for the method and system to provide a tank 302, or tanks 302, of the plurality of storages 300 that may be used for storing hydrogen at the first pressure below the compressed higher pressure, since each of the plurality of storages are for storing compressed hydrogen at the compressed higher pressure and each is subsea.

This written description uses examples to disclose the embodiments disclosed herein and also enable any person skilled in the art to practice the embodiments, including making and using the adapters and performing the methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### LIST OF ELEMENTS

100 electrolyser source
110 valve
200 compressor
205 valve
210 bypass line
300 plurality of storages
302 tank
310 valves
320 conduits
400 controller
500 energy producer
1000 producing hydrogen
2000 passing the hydrogen
3000 storing the hydrogen
4000 compressing the hydrogen
5000 storing the produced and compressed hydrogen

1.-14. (canceled)

15. A method for storing hydrogen in a system, the system including an electrolyser source for producing hydrogen at a source pressure, a downstream compressor for compressing the hydrogen from the source pressure to a compressed higher pressure, the compressed higher pressure greater than the source pressure, and at least one storage located subsea, the at least one storage for storing compressed hydrogen at the compressed higher pressure, the method comprising:
producing hydrogen via the electrolyser source at the source pressure; and
passing the hydrogen to the storage through a bypass line around the compressor and storing the hydrogen in the at least one storage at a first pressure, the first pressure less than the compressed higher pressure; or
compressing the hydrogen with the compressor to a storage pressure, the storage pressure less than the compressed higher pressure, and storing the compressed hydrogen in the storage at the storage pressure.

16. The method according to claim 1, wherein the system further comprises a controller configured for controlling the electrolyser source, the compressor, and a set of valves to the at least one storage, the method further comprising:
responsive to when a determination is made by the controller that less hydrogen is produced than a predetermined amount:
passing the hydrogen to the at least one storage through a bypass line around the compressor, and
storing the hydrogen in the at least one storage at the first; and
responsive to when the controller determines that more hydrogen is produced than a predetermined amount:
compressing the hydrogen with the compressor to the storage pressure, and
storing the compressed hydrogen in the at least one storage at the storage pressure.

17. The method according to claim 16, wherein the system further comprises an electric energy producer, the controller configured to control the electric energy producer, and wherein the method further comprises:
producing electric energy with the electric energy producer; and
conducting at least a part of the electric energy to the electrolyser source for producing hydrogen at the source pressure.

18. The method according to claim 15, wherein the first pressure is either one of: equal to the source pressure, less than the source pressure, or greater than the source pressure and lower than the compressed higher pressure.

19. The method according to claim 15, further comprising configuring the electrolyser source to produce hydrogen at the source pressure in kPa that is equal to, or greater than, ten (10) times the subsea depth in meters of the at least one storage.

20. The method according to claim 15, wherein hydrogen is deducted from a predetermined single tank, or a predetermined set of tanks, of the at least one storage until the predetermined single tank, or the predetermined set of tanks, are at the first pressure.

21. A system for storing hydrogen in at least one storage located subsea, the system comprising:
an electrolyser source for producing hydrogen at a source pressure;
a downstream compressor for compressing the hydrogen from the source pressure to a compressed higher pressure;
at least one storage for storing compressed hydrogen at the compressed higher pressure, the at least one storage being subsea; and
a controller for controlling the electrolyser source, the downstream compressor, and a set of valves to at least one storage,
wherein the controller is configured to either:
pass the hydrogen, produced by the electrolyser source at the source pressure, to the compressor, compress the hydrogen via the compressor to a compressed higher pressure, and pass the hydrogen, at the compressed higher pressure, from the compressor to at least one subsea storage, or
pass the hydrogen, produced by the electrolyser source at the source pressure, to at least one of the plurality of storages, through a bypass line around the compressor at a first pressure below the compressed higher pressure.

22. The system according to claim 21, wherein the controller and the compressor are above sea level.

23. The system according to claim 21, wherein the at least one storage is a plurality of storages connected in series or in parallel, and further comprising controllable valves for individually filling or individually emptying each of the plurality of storages.

24. The system according to claim 21, wherein the system further comprises an electric energy producer, the controller configured to control the electric energy producer.

25. The system according to claim 21, wherein the at least one storage is configured to be constantly pressurised with at least a pressure in kPa that is equal to 10 times a subsea depth in meters of the plurality of storages.

26. The system according to claim 21, wherein the electrolyser source is configured to produce hydrogen at the source pressure in kPa that is higher than 10 times the subsea depth in meters of the plurality of storages.

27. The system according to claim 21, further comprising at least one conduit leading from at least one storage to a topside at, or above, sea level for purging and maintaining the at least one storage, wherein one conduit of the at least one conduit is dedicated for passing hydrogen at the first pressure.

28. The system according to claim 21, wherein the first pressure is either one of: equal to the source pressure, less than the source pressure, or greater than the source pressure and lower than the compressed higher pressure.
